(19) United States
(12) Patent Application Publication
(10) Pub. No.: US 2016/0239800 A1
(43) Pub. Date: Aug. 18, 2016

(54) TRANSPORTATION NETWORK OPTIMIZATION

(71) Applicant: Ryder Integrated Logistics, Inc., Miami, FL (US)

(72) Inventors: Christopher Lee SCHARASWAK, Brighton, MI (US); Michael Alan Dupre', Colleyville, TX (US); William Landon Taylor, Burns, TN (US); Donald William Showell, Lawrenceville, GA (US)

(21) Appl. No.: 14/625,573

(22) Filed: Feb. 18, 2015

(51) Int. Cl. G06Q 10/08

(52) U.S. Cl. CPC G06Q 10/0835

(57) ABSTRACT

Techniques for transportation network optimization are provided. An example method includes receiving a shipment plan referencing one or more shipments associated with shipment carriers, where the shipment carriers include at least one common carrier fleet and at least one dedicated fleet, determining one or more constraints associated with the one or more shipment carriers included in the shipment plan, where the constraints include one or more of: driver hours of service, backhaul loads or shipments, the dedicated fleet equipment availability, the dedicated fleet's fixed cost and the dedicated fleet's shipment cost, or the common carrier fleet's shipment cost, wherein the dedicated fleet's shipment cost and the common carrier fleet's shipment cost are based on their respective lane rates, and generating an updated shipment plan based on selectively assigning the one or more shipments to the dedicated fleet or the common carrier fleet based on the determined constraints.

### BACKGROUND

The present disclosure relates generally to transportation management and particularly to dedicated fleets and common carriers.

### SUMMARY

The disclosed subject matter relates to transportation network optimization.

In some innovative implementations, the disclosed subject matter can be embodied in a method. The method comprises receiving a shipment plan referencing one or more shipments associated with shipment carriers, wherein the shipment carriers include at least one common carrier fleet and at least one dedicated fleet, determining one or more constraints associated with the one or more shipment carriers included in the shipment plan, wherein the constraints include one or more of: driver hours of service, dedicated fleet equipment availability, the dedicated fleet's fixed cost and the dedicated fleet's shipment cost, or the common carrier fleet's shipment cost, wherein the dedicated fleet's shipment cost and the common carrier fleet's shipment cost are based on their respective lane rates, and selectively assigning the one or more shipments to the dedicated fleet or the common carrier fleet based on the determined constraints,

In some innovative implementations, the disclosed subject matter can be embodied in a machine readable medium. The machine readable medium includes instructions, which when executed by a processor, cause the processor to perform operations including reading a shipment plan referencing one or more shipments associated with shipment carriers, wherein the shipment carriers include at least one common carrier fleet and at least one dedicated fleet, determining one or more constraints associated with the one or more shipment carriers included in the shipment plan, wherein the constraints include one or more of: driver hours of service, dedicated fleet equipment backhaul loads or shipments, the dedicated fleet's fixed cost and the dedicated fleet's shipment cost, or the common carrier fleet's shipment cost, wherein the dedicated fleet's shipment cost and the common carrier fleet's shipment cost are based on their respective lane rates; and selectively assigning the one or more shipments to the dedicated fleet or the common carrier fleet based on the determined constraints.

In some innovative implementations, the disclosed subject matter can be embodied in a system. The system comprises a memory comprising instructions and a processor configured to execute the instructions to receive a shipment plan referencing one or more shipments associated with shipment carriers, wherein the shipment carriers include at least one common carrier fleet and at least one dedicated fleet, determine one or more constraints associated with the one or more shipment carriers included in the shipment plan, wherein the constraints include one or more of: driver hours of service, dedicated fleet equipment availability, the dedicated fleet's fixed cost and the dedicated fleet's shipment cost, backhaul loads or shipments, or the common carrier fleet's shipment cost, where the dedicated fleet's shipment cost and the common carrier fleet's shipment cost are based on their respective lane rates; and generate an updated shipment plan based on selectively assigning the one or more shipments to the dedicated fleet or the common carrier fleet based on the determined constraints.

It is understood that other configurations of the subject technology will become readily apparent to those skilled in the art from the following detailed description, where various configurations of the subject technology are shown and described by way of illustration. As will be realized, the subject technology is capable of other and different configurations and its several details are capable of modification in various other respects, all without departing from the scope of the subject technology. Accordingly, the drawings and detailed description are to be regarded as illustrative in nature and not as restrictive.

### BRIEF DESCRIPTION OF THE DRAWINGS

The novel features of the subject technology are set forth in the appended claims. However, for purpose of explanation, several configurations of the subject technology are set forth in the accompanying figures summarized below.

FIG. 1 is a diagram of an example device and network environment suitable for practicing some implementations of the subject technology.

FIG. 2 is an example process that may be performed at an operations analyzer for practicing implementations of the subject technology using the example device of FIG. 1.

FIG. 3 is an example process that may be performed at a preliminary plan generator for practicing implementations of the subject technology using the example device of FIG. 1.

FIG. 4 is an example process that may be performed at a plan optimizer for practicing implementations of the subject technology using the example device of FIG. 1A.

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The subject technology is not limited to the specific details set forth herein and may be practiced without these specific details.

Implementing a dedicated fleet—assigning a group of tractors, trailers, drivers, and other resources exclusively to carry out operations for a chosen set of facilities or lanes in any transportation network—offers a number of potential advantages. Among the benefits shippers may derive are improved on-time delivery performance(s), guaranteed capacity, and reduced freight transportation costs. Relying on dedicated carriers' transportation management expertise also frees shippers to focus personnel and financial resources on business operations, such as manufacturing. In some cases, companies are looking at a best fit solution that combine both a dedicated fleet and a for-hire solution or common carrier solution. When considering switching over to a best fit solution, it is important to perform a careful analysis in order to find the best strategy to achieve a more efficient and cost effective operation. However, determining such a solution is a time consuming process that may not take into consideration relevant fleet constraints or even leverage the benefit of real-time fleet parameters.

The disclosed implementations include receive a shipment plan referencing one or more shipments associated with shipment carriers. As an example, the shipment plan may be received from a transportation management application operated by a shipping carrier. The shipment carriers referenced in the shipment plan may include at least one common carrier fleet and at least one dedicated fleet. The dedicated fleet may be owned or operated by a shipment customer or client. One or more constraints associated with the one or more shipment carriers included in the shipment plan may then be determined. The constraints can include one or more of: driver hours of service, dedicated fleet equipment availability, backhaul loads or shipments, the dedicated fleet's fixed cost and the dedicated fleet's shipment cost, or the common carrier fleet's shipment cost. The driver hours of service can reflect driver availability to service the shipment. The dedicated fleet's fixed cost is a cost that the dedicated fleet's owner or operator needs to pay to keep or maintain the fleet. These fixed costs may include, for example, maintenance, parking, information technology (IT), overhead, driver benefits, management team, etc. The dedicated fleet's shipment cost and the common carrier fleet's shipment cost are based on their respective lane rates, which include both fixed costs and variable costs. In some cases, the common carrier fleet's shipment costs may be less than the dedicated fleet's shipment costs (or vice versa). The disclosed implementations can then generate an updated shipment plan based on selectively assigning the one or more shipments to the dedicated fleet or the common carrier fleet based on the determined constraints. Shipping customers may use the updated plan to achieve a more efficient and cost effective operation.

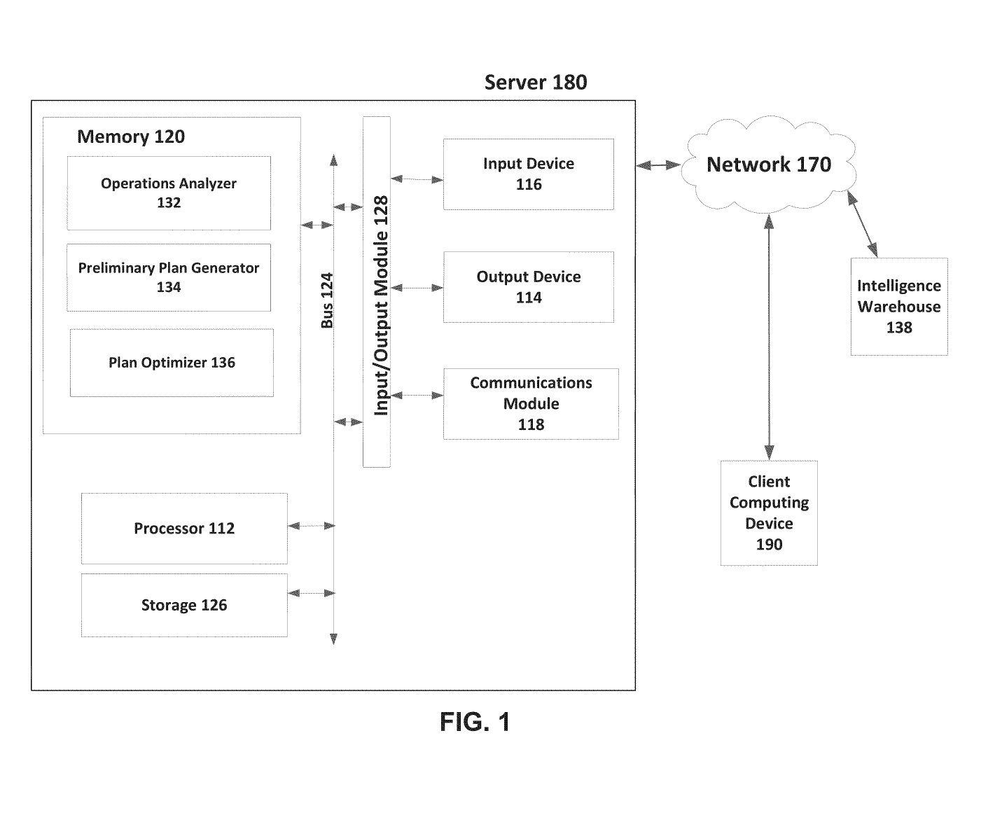

FIG. 1 is a diagram illustrating example architecture for transportation network optimization. Server 180 includes processor 112, memory 120, storage 126, bus 124, input/output module 128, input device 116, output device 114 and communications module 118. Memory 120 includes operations analyzer 132, preliminary plan generator 134, plan optimizer 136. Server 180 may also communicate with intelligence database 138. In some implementations, server 180 includes one or more modules for facilitating user interaction via a browser, web application or a special purpose application executing on client computing device 190. Server 180 may be implemented as a single machine with a single processor, a multi-processor machine, or a server farm including multiple machines with multiple processors. Communication module 118 can enable server 180 to send data to client computing device 190.

Client computing device 190 can be a laptop computer, a desktop computer, a mobile phone, a personal digital assistant (PDA), a tablet computer, a netbook, a monitor with one or more processors embedded therein or coupled thereto, a physical machine, or a virtual machine. Client computing device 190 may include one or more of a keyboard, a mouse, a display, or a touch screen. Client computing device 190 can include a browser or any web application configured to display webpages or any web content. Alternatively, client computing device 190 may include special-purpose applications (e.g., mobile phone or tablet computer applications) for accessing and displaying content.

In some implementations, server 180, intelligence database 138 and client computing device 190 can communicate with one another via network 150. Network 150 may include the Internet, an intranet, a local area network, a wide area network, a wired network, a wireless network, or a virtual private network (VPN). While only one server 180 is illustrated, the subject technology may be implemented in conjunction with any number of servers 180 and client computing devices 190. In some non-limiting implementations, a plurality of servers may implement the functions of server 180 and other components illustrated in FIG. 1A.

As discussed above, memory 120 of server 180 can include operations analyzer 132, preliminary plan generator 134, plan optimizer 136. Server 180 may also communicate with intelligence database 138.

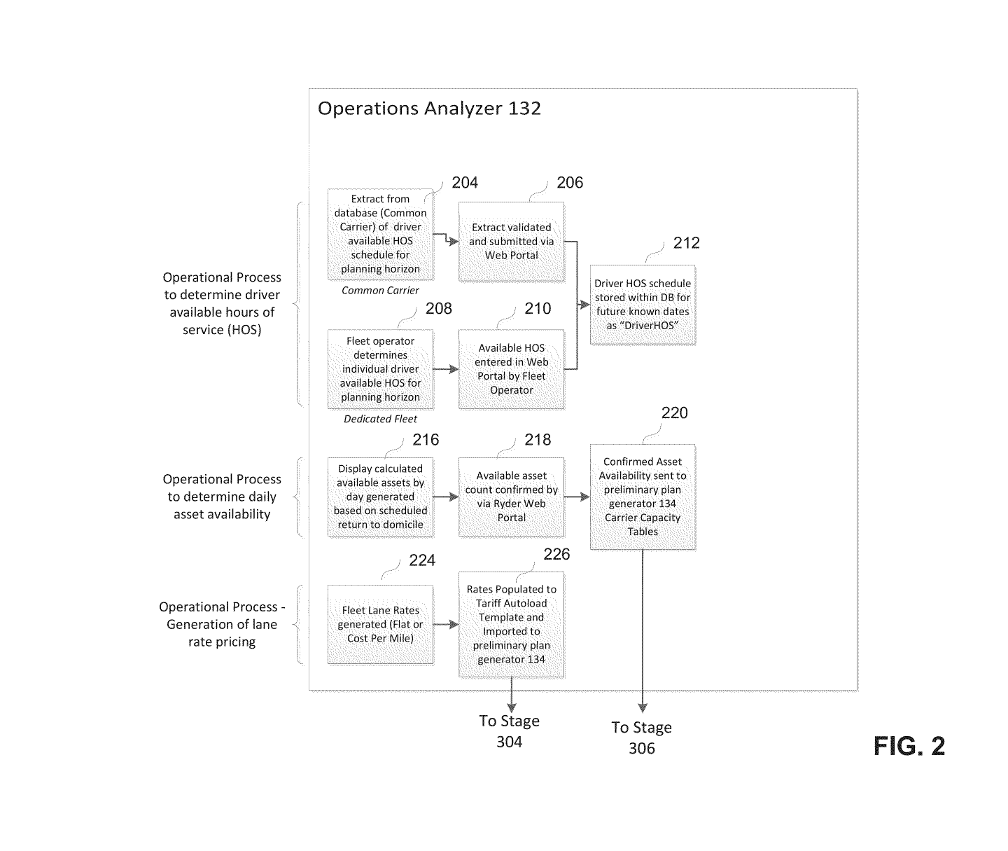

FIG. 2 illustrates an example view of different operational stages in operations analyzer 132 in greater detail. Stage 204 is an example operational proves to determine driver available hours of service (HOS). In some implementations, to determine driver HOS, operations analyzer 132 assesses both the common carrier fleet and the private or dedicated fleet. Referring to FIG. 2, a common carrier fleet operator may determine driver HOS for the planning horizon (stage 204) and may enter the driver HOS into the web-based application or the operations analyzer 132 may extract from a fleet management system of the common carrier driver available HOS for a particular planning horizon (e.g., 1 day, 1 week, etc.) (stage 204).

The extracted data may then be validated and submitted for storage via a web-based application or a web portal associated with a transportation management application (stage 206). In parallel, a dedicated fleet operator may determine driver HOS for the planning horizon (stage 208) and may enter the driver HOS into the web-based application (stage 210) or extract from a Fleet Management System. Operations analyzer 132 may then store a combined driver HOS schedule into intelligence database 138 (stage 212).

Stage 216 is an example operational process to determine daily asset (e.g., truck, vehicle, etc.) availability. In some implementations, stage 216 may be performed by operations analyzer 132 in parallel with stage 204. Stage 216 may include one or more substages. For example, in stage 216, operations analyzer 132 may display available assets for a day. The assets for a day may be generated based on a scheduled return to domicile (or a point of shipment origin).

The available asset count may then be confirmed by the operations analyzer (stage 218). The confirmed asset availability may then be sent to preliminary plan generator 134 (stage 220). As an example, the confirmed asset availability may be sent by as database table including one or more rows and columns identifying assets and their respective availability.

Stage 224 is an operational process that generates lane rate pricing. In some implementations, stage 224 may include one or more sub-stages. For example, in stage 224 operations analyzer 132 may generate fleet lane rates (e.g., flat or cost per mile). The rates can then populated to a tariff template that may be provided to or imported by the preliminary plan generator 134.

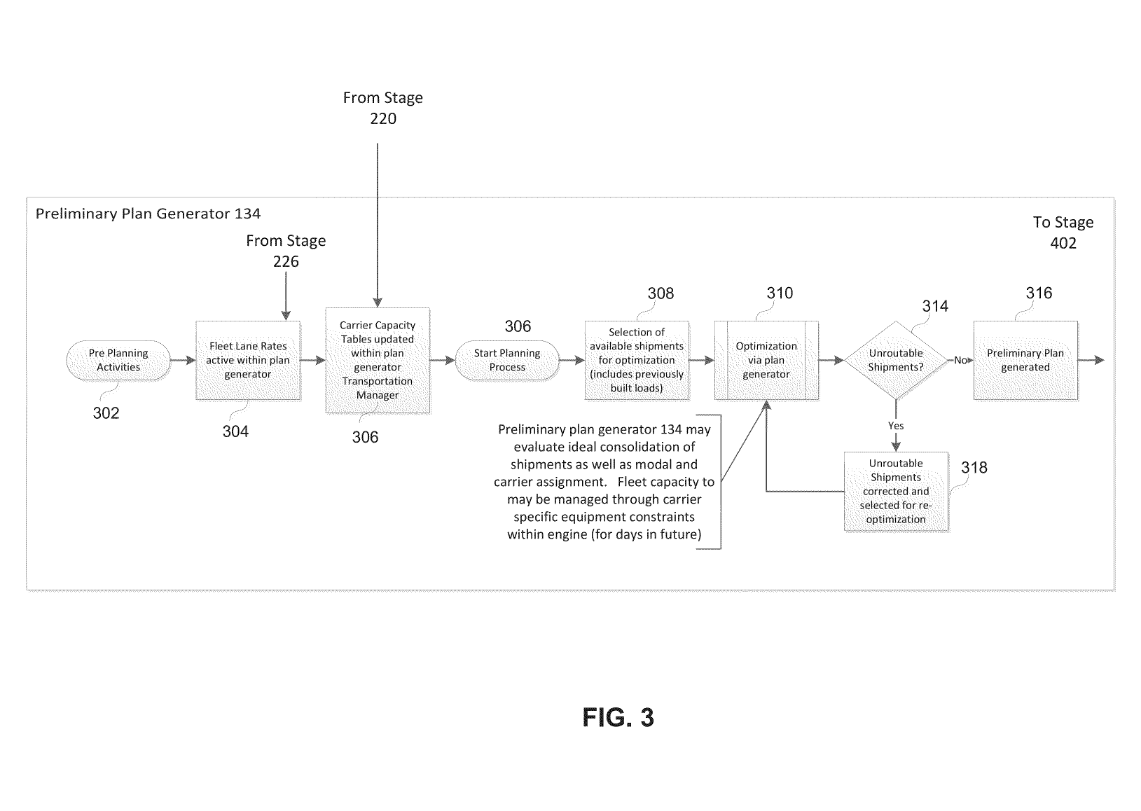

FIG. 3 illustrates preliminary plan generator 134 in greater detail according to some implementations. In some implementations, preliminary plan generator 134 may perform one or more pre-planning activities 302 that may include receiving (or activating) one or more fleet lane rates (stage 304). The fleet lane rates may be received from stage 226 of the operations analyzer 132 discussed above with reference to FIG. 2.

Carrier capacity tables (or asset availability) tables may be updated by the preliminary plan generator 134 based on confirmed asset availability determined by operations analyzer 132 in stage 220. Preliminary plan generator 134 may then start the planning process 306. During the planning process 308, preliminary plan generator may select one or more shipments for optimization (stage 308). The shipments may include previously built loads or shipments. Preliminary plan generator 134 may then initiate an optimization process to select assets associated with lowest lane rates (stage 310).

In other words, preliminary plan generator 134 may optimize based using lane rate as a metric (stage 310). If it is determined that there are un-routable shipments (stage 314), preliminary plan generator 134 may correct the un-routable shipments and select the corrected shipments for re-optimization (stage 318). If it is determined that there are no un-routable shipments (stage 314), preliminary plan generator 134 can generate a preliminary plan (stage 316). As an example, the preliminary plan may have a table format (e.g., a database table). The database table may include in one or more rows and columns shipment origin information, customer name, customer code, city name, state name, zip code, distance between origin and destination, transit time between origin and destination, destination zip code, shipment characteristics, freight class special handling requirements, assigned carrier, lane rates for each available carrier, etc. The preliminary plan can indicate a mapping between orders and one or more carriers. The one or more carriers may be selected based on the lowest lane rate while fulfilling shipment characteristics.

In some implementations, plan optimizer 136 receives a shipment plan referencing one or more shipments associated with shipment carriers. As an example, the shipment carriers can include at least one common carrier fleet and at least one dedicated fleet. Plan optimizer 136 can determine one or more constraints associated with the one or more shipment carriers included in the shipment plan, wherein the constraints include one or more of: driver hours of service, the dedicated fleet equipment availability, backhaul loads or shipments, the dedicated fleet's fixed cost and the dedicated fleet's shipment cost, or the common carrier fleet's shipment cost, wherein the dedicated fleet's shipment cost and the common carrier fleet's shipment cost are based on their respective lane rates. Plan optimizer 136 may then generate an updated shipment plan based on selectively assigning the one or more shipments to the dedicated fleet or the common carrier fleet based on the determined constraints.

In some implementations, plan optimizer 136 computes a cost comparison between to move a shipment with a common carrier fleet versus the dedicated fleet. If the common carrier fleet rate (e.g., $1000) is less than the dedicated fleet rate (e.g. $1200), the preliminary plan generator (134) would choose the common carrier as the lowest lane rate option. Plan optimizer 136 will compute and choose the carrier with the lowest penalty cost. Two different penalty costs can be computed. The first penalty cost can be derived by comparing the common carrier fleet lane rate (e.g., $1000) and the dedicated fleet lane rate (e.g., $1200) to compute a penalty cost (e.g., $200), if the plan optimizer assigned the dedicated fleet. Second, by adding the common carrier fleet lane rate (e.g., $1000) and the fixed cost portion of the dedicated fleet lane rate (e.g., $500) to derive a total cost (e.g., $1500) if the plan optimizer assigned the common carrier and then comparing the total cost (e.g., $1500) to the dedicated fleet lane rate (e.g., $1200) to derive a second penalty cost (e.g., $300) The plan optimizer 136 may then perform the selective assignment based on the first penalty cost and the second penalty cost.

In some implementations, plan optimizer 136 may compare the first penalty cost to the second penalty cost and when it its determined that the first penalty cost is lower than the second penalty cost, keep the shipment assigned to the dedicated fleet. In some implementations, plan optimizer 136 may compare the first penalty cost to the second penalty cost, and when it its determined that the first penalty cost is higher than the second penalty cost, assign the shipment to the common carrier fleet.

In some implementations, plan optimizer 136 provides the updated shipment plan to a shipment tendering system. The shipment tendering system negotiates one or more tenders to assign the shipment to the common carrier. Plan optimizer 136 may also provide the updated shipment plan to a fleet management system for assignment to the dedicated fleet. Plan optimizer 136 or operations analyzer 132 may then execute the updated shipment plan, where the execution includes transmitting one or more notifications to drivers, the notifications including instructions regarding the shipments.

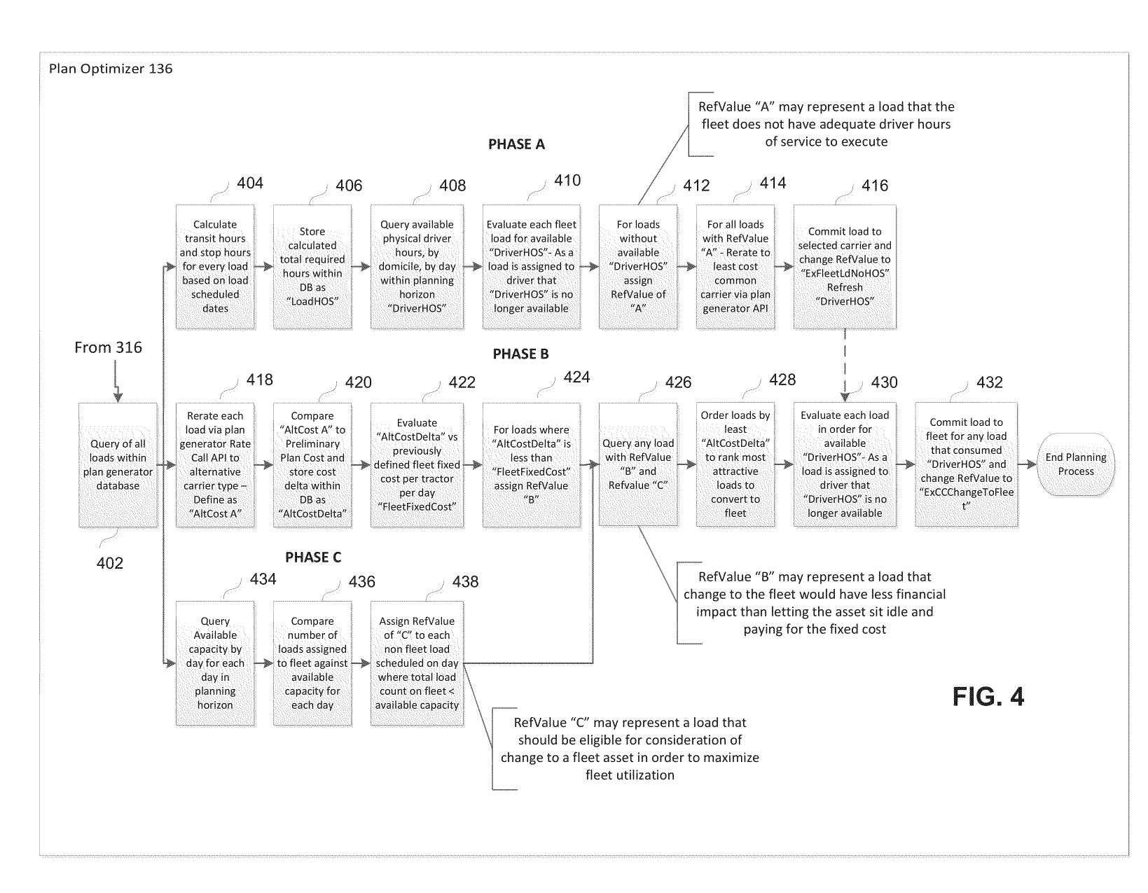

FIG. 4 illustrates plan optimizer 136 in greater detail. In some implementations, plan optimizer 136 may operate in three parallel phases A, B and C. In some implementations, and as an example overall operation, phase A reviews shipments that have been assigned to a fleet and reviews fleet hours of service to ensure that loads are not overcommitted with regard to driver HOS. In some implementations, phase B determines whether a particular shipment can stay assigned to a dedicated fleet or whether it may need to be shifted to a common carrier fleet (or vice versa). Phase C makes a determination of what assets (e.g., vehicles) are available and provides the determination to Phase B.

In some implementations, plan optimizer 136 may query, receive or read the preliminary plan shipments and assets generated by preliminary plan generator 134 (stage 402). In Phase A, which begins with stage 404, plan optimizer 136 calculates transit hours and stop hours for each load or shipment based on shipment scheduled dates (stage 404). Plan optimizer 136 may then store the calculated total in a database (e.g., intelligence database 138) as, for example, load hours of service (HOS) (stage 406). Driver available hours of service by domicile, or by day may be queried within a planning horizon (stage 410). For loads or shipments without available driver HOS a reference value of A may be assigned (stage 412). The reference value A may represent a load that a fleet does not have adequate hours of service to execute. Then, for all loads with a reference value A, plan optimizer 136 may rerate the loads to a lowest or least cost carrier via an application programming interface (API) associated with the preliminary plan generator 134 (stage 414). Plan optimize 136 may then commit the load to the lowest or least cost carrier (stage 416). Additionally, plan optimizer 136 may change the reference value of A (assigned in stage 412) to a value that may be “ExFleetLdNoHOS” and may also refresh a value of driver HOS.

In Phase B, begins with plan optimizer 136 rerating each load via a preliminary plan generator 134 API to an alternative carrier type (or moved from dedicated fleet to common carrier or vice versa) (stage 418). As an illustrative example, this rerated cost may be defined as “AltCostA.” In stage 420, plan optimizer 136 compares “AltCostA” to an analogous cost generated by preliminary plan generator 134 and stores a difference (or delta) between these costs. As an example, the difference value may he defined as “AltCostDelta.” In stage 422, plan optimizer 136 may evaluate the previously computed “AltCostDelta” to a previously defined fleet fixed cost per vehicle asset per day (e.g., “FleetFixedCost”). Then, for loads or shipments where “AltCostDelta” is less than “FleetFixedCost,” plan optimizer 136 may assign a reference value of “B” (stage 424).

Reference value B may represent a load that when assigned to a dedicate fleet would have less financial impact than allowing the dedicated fleet asset to sit idle and paying for a fixed cost associated with the dedicated fleet asset. Plan optimizer 136 may then query any load that is referenced by a reference value or “B” and “C” (stage 426). In stage 428, plan optimizer 136 may order loads by a least value of “AltCostDelta.”

In this way, plan optimizer 136 generates a ranking of loads or shipments that may be moved from a dedicated fleet to a common carrier fleet. Plan optimizer 136 may proceed by evaluating each ranked load with consideration to driver HOS to prevent a load from being assigned to a driver without HOS available (stage 430). Stage 430 may also receive input from stage 416 from Phase A of plan optimizer 136. Plan optimizer 136 may then commit each load to a fleet that have driver HOS available and change the reference value from “B” to “ExCCCharigeToFleet” (stage 430) and the planning process may end (stage 432).

In Phase C, plan optimizer 136 may query available capacity of a dedicated fleet by day for each day for the planning horizon (stage 434). Plan optimizer 136 may then compare a number of loads assigned to a dedicated fleet against the fleet's available capacity for each day (stage 436). Plan optimizer 136 may then assign a reference value of “C” to each non fleet load scheduled on a day where a total load count on a fleet may be less than an available capacity (stage 438). Reference value C may reference a load that may be eligible for consideration of change to a dedicated fleet asset in order to maximize dedicated fleet performance. In some implementations, the output of stage 438 may be provided by plan optimizer 136 to stage 426 of phase B as a part of the planning process.

In some implementations, intelligence database 138 may communicate with plan optimizer 136. Intelligence database 138 may also communicate with preliminary plan generator 134 and operations analyzer 132. In some implementations, plan optimizer 136 may store data gathered during the optimization process performed by plan optimizer 136. This data may include, but is not limited to:

1. Daily Driver Hours of Service

2. Load—hours of Service Required

3. Alternative cost solution (common carrier or fleet) for every load

4. Difference of cost bet peen common carrier and fleet for all loads

5. Total available physical assets by day by domicile

6. Designation of loads that were changed from common carrier to fleet

7. Designation of loads that did not have enough available hours of service to execute to fleet.

8. Designation of loads in which the penalty cost between common carrier and fleet is less than the penalty cost of the common carrier cost plus the fixed cost of tractor per day compared to dedicated fleet cost. In some implementations, intelligence database 138 may generate new analytics that comprise one or more of:

1. Daily Driver Utilization

2. Daily Asset Utilization

3. Savings—Generated by fleet or common carrier.

4. Lost opportunity of under-utilization of fleet

5. Measurement of baseline engineering against actual execution

6. Future lane opportunity for expansion of the fleet

7. Output for Visual Representation

Returning to FIG. 1, in certain aspects, server 180 may be implemented using hardware or a combination of software and hardware, either in a dedicated server, or integrated into another entity, or distributed across multiple entities.

Server 180 includes a bus 124 or other communication mechanism for communicating information, and processor 112 coupled with bus 124 for processing information. Processor 112 may be a general-purpose microprocessor, a microcontroller, a Digital Signal Processor (DSP), an Application Specific Integrated Circuit (ASIC), a Field Programmable Gate Array (FPGA), a Programmable Logic Device (PLD), a controller, a state machine, gated logic, discrete hardware components, or any other suitable entity that can perform calculations or other manipulations of information.

Server 180 can include, in addition to hardware, code that creates an execution environment for the computer program in question, e.g., code that constitutes processor firmware, a protocol stack, a database management system, an operating system, or a combination of one or more of them stored in memory 120. Memory 120 may include Random Access Memory (RAM), a flash memory, a Read Only Memory (ROM), a Programmable Read-Only Memory (PROM), an Erasable PROM (EPROM), registers, a hard disk, a removable disk, a CD-ROM, a DVD, or any other suitable storage device, coupled to bus 124 for storing information and instructions to be executed by processor 112. The processor 112 and the memory 120 can be supplemented by, or incorporated in, special purpose logic circuitry.

The instructions may be stored in the memory 120 and implemented in one or more computer program products, i.e., one or more modules of computer program instructions encoded on a computer readable medium for execution by, or to control the operation of, the server 180, and according to any method well known to those of skill in the art, including, but not limited to, computer languages such as data-oriented languages SQL, dBase), system languages (e.g., C, Objective-C, C++, Assembly), architectural languages (e.g., Java, .NET), and application languages (e.g., PHP, Ruby, Perl, Python). Instructions may also be implemented in computer languages such as array languages, aspect-oriented languages, assembly languages, authoring languages, command line interface languages, compiled languages, concurrent languages, curly-bracket languages, dataflow languages, data-structured languages, declarative languages, esoteric languages, extension languages, fourth-generation languages, functional languages, interactive mode languages, interpreted languages, iterative languages, list-based languages, little languages, logic-based languages, machine languages, macro languages, metaprogramming languages, multiparadigm languages, numerical analysis, non-English-based languages, object-oriented class-based languages, object-oriented prototype-based languages, off-side rule languages, procedural languages, reflective languages, rule-based languages, scripting languages, stack-based languages, synchronous languages, syntax handling languages, visual languages, wirth languages, embeddable languages, and xml-based languages. Memory 120 may also be used for storing temporary variable or other intermediate information during execution of instructions to be executed by processor 112.

A computer program as discussed herein does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, subprograms, or portions of code). A computer program can be deployed to be executed on one computer or on multiple computers that are located at one site or distributed across multiple sites and interconnected by a communication network. The processes and logic flows described in this specification can be performed by one or more programmable processors executing one or more computer programs to perform functions by operating on input data and generating output.

Server 180 further includes a data storage device 126 such as a magnetic disk or optical disk, coupled to bus 124 for storing information and instructions. Server 180 may be coupled via input/output module 128 to various devices. The input/output module 128 can be any input/output module. Example input/output modules 128 include data ports such as USB ports. The input/output module 128 is configured to connect to a communications module 118. Example communications modules 118 (e.g., communications module 118 and 238) include networking interface cards, such as Ethernet cards and modems. In certain aspects, the input/output module 128 is configured to connect to a plurality of devices, such as an input device 116 and/or an output device 114. Example input devices 114 include a keyboard and a pointing device, e.g., a mouse or a trackball, by which a user can provide input to the server 180. Other kinds of input devices 114 can be used to provide for interaction with a user as well, such as a tactile input device, visual input device, audio input device, or brain-computer interface device. For example, feedback provided to the user can be any form of sensory feedback, visual feedback, auditory feedback, or tactile feedback; and input from the user can be received in any form, including acoustic, speech, tactile, or brain wave input, Example output devices 116 include display devices, such as a LED (light emitting diode), CRT (cathode ray tube), or LCD (liquid crystal display) screen, for displaying information to the user.

According to one aspect of the present disclosure, server 180 can be implemented using a server 180 in response to processor 112 executing one or more sequences of one or more instructions contained in memory 120. Such instructions may be read into memory 120 from another machine-readable medium, such as data storage device 126. Execution of the sequences of instructions contained in main memory 120 causes processor 112 to perform the process blocks described herein. One or more processors in a multi-processing arrangement may also be employed to execute the sequences of instructions contained in memory 120. In alternative aspects, hard-wired circuitry may be used in place of or in combination with software instructions to implement various aspects of the present disclosure. Thus, aspects of the present disclosure are not limited to any specific combination of hardware circuitry and software.

Various aspects of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. The communication network (e.g., network 150) can include, for example, any one or more of a personal area network (PAN), a local area network (LAN), a campus area network (CAN), a metropolitan area network (MAN), a wide area network (WAN), a broadband network (BBN), the Internet, and the like. Further, the communication network can include, but is not limited to, for example, any one or more of the following network topologies, including a bus network, a star network, a ring network, a mesh network, a star-bus network, tree or hierarchical network, or the like. The communications modules can be, for example, modems or Ethernet cards.

Server 180 can be, for example, and without limitation, a desktop computer, laptop computer, or tablet computer. Server 180 can also be embedded in another device, for example, and without limitation, a mobile telephone, a personal digital assistant (PDA), a mobile audio player, a Global Positioning System (GPS) receiver, a video game console, and/or a television set top box.

The term “machine-readable storage medium” or “computer readable medium” as used herein refers to any medium or media that participates in providing instructions or data to processor 112 for execution. Such a medium may take many forms, including, but not limited to, non-volatile media and volatile media. Non-volatile media include, for example, optical disks, magnetic disks, or flash memory, such as data storage device 126. Volatile media include dynamic memory, such as memory 120. Transmission media include coaxial cables, copper wire, and fiber optics, including the wires that comprise bus 124. Common forms of machine-readable media include, for example, floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH EPROM, any other memory chip or cartridge, or any other medium from which a computer can read. The machine-readable storage medium can be a machine-readable storage device, a machine-readable storage substrate, a memory device, a composition of matter effecting a machine-readable propagated signal, or a combination of one or more of them.

As used herein, the phrase: “at least one of” preceding a series of items, with the terms “and” or “or” to separate any of the items, modifies the list as a whole, rather than each member of the list (i.e., each item). The phrase “at least one of” does not require selection of at least one item; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

Furthermore, to the extent that the term “include,” “have,” or the like is used in the description or the claims, such term is intended to be inclusive in a manner similar to the term “comprise” as “comprise” is interpreted when employed as a transitional word in a claim.

A reference to an element in the singular is not intended to mean “one and only one” unless specifically stated, but rather “one or more.” All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description.

While this specification contains many specifics, these should not be construed as limitations on the scope of what may be claimed, but rather as descriptions of particular implementations of the subject matter. Certain features that are described in this specification in the context of separate aspects can also be implemented in combination in a single aspect. Conversely, various features that are described in the context of a single aspects can also be implemented in multiple aspects separately or in any suitable subcombination. Moreover, although features may be described above as acting in certain combinations and even initially claimed as such, one or more features from a claimed combination can in some cases be excised from the combination, and the claimed combination may he directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the aspects described above should not be understood as requiring such separation in all aspects, and it should be understood that the described program components and systems can generally be integrated together in a single software product or packaged into multiple software products.

The subject matter of this specification has been described in terms of particular aspects, but other aspects can be implemented and are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous. Other variations are within the scope of the following claims.

These and other implementations are within the scope of the following claims.

1. A method comprising:
receiving, via an electronic network by one or more computing devices operated at a dedicated carrier, a shipment plan referencing one or more shipments associated with shipment carriers, wherein the shipment carriers include at least one common carrier fleet operated by a common carrier and at least one dedicated fleet operated by the dedicated carrier, the shipment dedicated fleet;
determining, by the one or more computing devices, one or more real-time constraints associated with the one or more shipment carriers included in the shipment plan;
selectively assigning, by the one or more computing devices in real-time with the determining and without user intervention, the one or more shipments to the dedicated fleet or the common carrier fleet based on the determined one or more real-time constraints and based on the dedicated fleet's shipment cost, the dedicated fleet's fixed cost for operating the dedicated fleet, and the common carrier's fleet's shipment cost, wherein the dedicated fleet's shipment cost and the common carrier fleet's shipment cost are based on their respective lane rates;
generating in real time, from the received shipment plan without user intervention, an updated shipment plan based on the selective assignment of the one or more shipments; and
providing, via the electronic network without user intervention, the updated shipment plan to a fleet management system.

2. The method of claim 1, further comprising:
computing a first penalty cost to move a shipment of the one or more shipments from the common carrier fleet to the dedicated fleet, wherein the first penalty cost is based on a difference between the common carrier fleet's shipment cost and the dedicated fleet's shipment cost;
computing a second penalty cost to keep the shipment on the common carrier, wherein the second penalty cost is based on a difference between the dedicated fleet's shipment cost and a summation of the dedicated fleet's fixed cost and the common carrier fleet's shipment cost; and
performing the selective assignment based on the first penalty cost and the second penalty cost.

3. The method of claim 2, further comprising:
comparing the first penalty cost to the second penalty cost; and
when it its determined that the first penalty cost is lower than the second penalty cost, assigning the shipment to the dedicated fleet.

4. The method of claim 2, further comprising:
comparing the first penalty cost to the second penalty cost; and
when it its determined that the first penalty cost is higher than the second penalty cost, assigning the shipment to the common carrier fleet.

5. The method of claim 1, further comprising:
providing the updated shipment plan to a shipment tendering system, wherein the shipment tendering system negotiates one or more tenders to assign the shipment to the common carrier wherein the updated shipment plan is provided to the fleet management system for assignment to the dedicated fleet.

6. The method of claim 1, further comprising:
storing, in a database, data identifying the selectively assigned shipments over time; and
analyzing the data in the database to generate one or more recommendations to alter fleet characteristics of the shipment carriers.

7. A non-transitory machine-readable medium comprising instructions stored therein, which when executed by a processor, causes the processor to perform operations comprising:
reading, via an electronic network by one or more computing deices operated at a dedicated carrier, a shipment plan referencing one or more shipments associated with shipment carriers, wherein the shipment carriers include at least one common carrier fleet operated by a common carrier and at least one dedicated fleet operated by the dedicated carrier, the shipment plan including respective lane rates for the at least one common carrier fleet and the at least one dedicated fleet;
determining one or more real-time constraints associated with the one or more shipment carriers included in the shipment plan;
selectively assigning, in real-time with the determining and without user intervention, the one or more shipments to the dedicated fleet or the common carrier fleet based on the determined one or more real-time constraints and based on the dedicated fleet's shipment cost, the dedicated fleet's fixed cost for operating the dedicated fleet, and the common carrier's fleet's shipment cost, wherein the dedicated fleet's shipment cost and the common carrier fleet's shipment cost are based on their respective lane rates;
generating in real time, from the received shipment plan without user intervention, an undated shipment plan based on the selective assignment of the one or more shipments; and
providing, via the electronic network without user intervention, the updated shipment plan to a fleet management system.

8. The machine-readable medium of claim 7, the operations further comprising:
computing a first penalty cost to move a shipment of the one or more shipments from the common carrier fleet to the dedicated fleet, wherein the first penalty cost is based on a difference between the common carrier fleet's shipment cost and the dedicated fleet's shipment cost;
computing a second penalty cost to keep the shipment on the common carrier, wherein the second penalty cost is based on a difference between the dedicated fleet's shipment cost and a summation of the dedicated fleet's fixed cost and the common carrier fleet's shipment cost; and
performing the selective assignment based on the first penalty cost and the second penalty cost.

9. The machine-readable medium of claim 8, the operations further comprising:
comparing the first penalty cost to the second penalty cost; and
when it its determined that the first penalty cost is lower than the second penalty cost, assigning the shipment to the dedicated fleet.

10. The machine-readable medium of claim 8, further comprising:
comparing the first penalty cost to the second penalty cost; and
when it its determined that the first penalty cost is higher than the second penalty cost, assigning the shipment to the common carrier fleet.

11. The machine-readable medium of claim 8, further comprising:
providing the updated shipment plan to a shipment tendering system, wherein the shipment tendering system negotiates one or more tenders to assign the shipment to the common carrier and wherein the updated shipment plan is provided to the fleet management system for assignment to the dedicated fleet.

12. The machine-readable medium of claim 7, further comprising:
storing, in a database, data identifying the selectively assigned shipments over time; and
analyzing the data in the database to generate one or more recommendations to alter fleet characteristics of the shipment carriers.

13. A system operated at a dedicated carrier comprising:
a memory comprising instructions; and
a processor configured to execute the instructions to:
receive, via an electronic network, a shipment plan referencing one or more shipments associated with shipment carriers, wherein the shipment carriers include at least one common carrier fleet operated by a common carrier and at least one dedicated fleet operated by the dedicated carrier, the shipment plan including respective lane rates for the at least one common carrier fleet and the at least one dedicated fleet;
determine one or more real-time constraints associated with the one or more shipment carriers included in the shipment plan;
generate, from the received shipment plan in real time without user intervention, an updated shipment plan based on selectively assigning, in real time without user intervention, the one or more shipments to the dedicated fleet or the common carrier fleet based on the determined one or more real-time constraints and a cost based on the dedicated fleet's shipment cost, the dedicated ^{.}fleet's fixed cost for operating the dedicated fleet, and the common carrier's fleet's shipment cost, wherein the dedicated fleet's shipment cost and the common carrier fleet's shipment cost are based on their respective lane rates; and
providing, via the electronic network without user intervention, the updated shipment plan to a fleet management system.

14. The system of claim 13, further comprising instructions to:
compute a first penalty cost to move a shipment of the one or more shipments from the common carrier fleet to the dedicated fleet, wherein the first penalty cost is based on a difference between the common carrier fleet's shipment cost and the dedicated fleet's shipment cost;
compute a second penalty cost to keep the shipment on the common carrier, wherein the second penalty cost is based on a difference between the dedicated fleet's shipment cost and a summation of the dedicated fleet's fixed cost and the common carrier fleet's shipment cost; and
perform the selective assignment based on the first penalty cost and the second penalty cost.

15. The system of claim 14, further comprising instructions to:
compare the first penalty cost to the second penalty cost; and
when it its determined that the first penalty cost is lower than the second penalty cost, assign the shipment to the dedicated fleet.

16. The system of claim 14, further comprising instructions to:
compare the first penalty cost to the second penalty cost; and
when it its determined that the first penalty cost is higher than the second penalty cost, assign the shipment to the common carrier fleet.

17. The system of claim 13, further comprising instructions to:
provide the updated shipment plan to a shipment tendering system, wherein the shipment tendering system negotiates one or more tenders to assign the shipment to the common carrier wherein the updated shipment plan is provided to the fleet management system for assignment to the dedicated fleet.

18. The system of claim 13, further comprising:
storing, in a database, data identifying the selectively assigned shipments over time; and
analyzing the data in the database to generate one or more recommendations to alter fleet characteristics of the shipment carriers.

19. (canceled)

20. (canceled)

21. The method of claim 1, wherein the determining comprises extracting, from one or more fleet management systems without user intervention, real-time parameters comprising driver hours of service (HOS) for the at least one common carrier fleet and the at least one dedicated fleet for a planning horizon associated with the one or more shipments; and
determining, in response to the extracting without user intervention, whether the driver HOS for at least one of the shipment carriers is overcommitted, wherein the assigning is based on whether the driver HOS for the at least one of the shipment carriers is overcommitted.

22. The method of claim 1, further comprising:
executing, by the one or more computing devices without user intervention, the updated shipment plan, wherein the execution comprises transmitting one or more notifications to drivers, the notifications including instructions regarding the one or more shipments.
